(19) United States
(12) Patent Application Publication
(10) Pub. No.: US 2026/0309202 A1
(43) Pub. Date: Oct. 8, 2026

(54) VIBRATION DAMPER, MOTOR VEHICLE AND METHOD FOR FILLING

(71) Applicants: thyssenkrupp Bilstein GmbH, Ennepetal (DE); thyssenkrupp AG, Essen (DE)

(72) Inventor: Freddy WOENARTA, Braunschweig (DE)

(73) Assignees: thyssenkrupp Bilstein GmbH, Ennepetal (DE); thyssenkrupp AG, Essen (DE)

(21) Appl. No.: 19/633,381

(22) Filed: Mar. 30, 2026

(30) Foreign Application Priority Data
Apr. 7, 2025 (DE) 10 2025 113 476.6

(51) Int. Cl. F16F 9/34; F16F 9/19; F16F 9/43; F16F 9/46

(52) U.S. Cl. CPC F16F 9/34; F16F 9/19; F16F 9/43; F16F 9/46; F16F 2222/12; F16F 2228/066; F16F 2232/08; F16F 2234/02

(57) ABSTRACT

A vibration damper, in particular for a motor vehicle, comprises: a hydraulic device for damping vibrations; a valve block and at least one shut-off valve integrated into the valve block and having at least one valve piston which is displaceable in a valve longitudinal direction for taking up at least two switching positions; and at least one nozzle for connecting a pump, which nozzle is adjustably fastened to the valve block, wherein the nozzle interacts with the valve piston for displacement between the switching positions, wherein, in the first switching position of the valve piston, the nozzle is fluidly separated from the hydraulic device and can be fluidly connected to at least one filling device for filling the pump with a hydraulic fluid, and in the second switching position of the valve piston, the nozzle is fluidly connected to the hydraulic device.

### CROSS REFERENCE TO RELATED APPLICATION

This application is a U.S. Non-Provisional that claims priority to German Patent Application No. DE 10 2025 113 476.6, filed Apr. 7, 2025, the entire content of which is incorporated herein by reference.

### FIELD

The present disclosure relates to a vibration damper, a motor vehicle and a method for filling a pump.

### BACKGROUND

Vibration dampers for motor vehicles having a hydraulic device for damping vibrations are known. The hydraulic device of the vibration damper converts kinetic energy into thermal energy through fluid friction. This occurs in a known manner by braking the flow of hydraulic oil by valve passages. For active vibration damping, it is known to connect the compression and rebound stage of the vibration damper to an external motor pump. Typically, the preassembled motor pump is delivered together with the vibration damper as a unit filled with hydraulic oil. The final assembly of the active vibration damper can cause problems if the installation space in the vehicle is limited and the assembly of the active vibration damper is obstructed by the restricted installation space.

For example, DE 10 2018 118 911 A1 discloses a vibration damper by means of which it is made possible to deliver the external motor pump and the vibration damper separately, with the connection of the pump and vibration damper occurring only during installation on the vehicle. For this purpose, the vibration damper has a shut-off valve which is fluidly connected to the hydraulic device for damping the vibrations. The shut-off valve is designed in such a way that it allows a fluid connection with a pump or a filling device for filling the vibration damper with hydraulic fluid. The shut-off valve has a total of three ports for connecting the hydraulic device, the pump and the filling device. An axial displacement of a valve piston releases or blocks the ports in different ways. The valve piston is actuated by screwing or unscrewing the valve piston, which is in threaded engagement with a valve housing. The shut-off valve is designed in such a way that the interconnection of the individual fluid paths for blocking or releasing the fluid flow through the valve piston and the connection of the pump, and thus the connection of the pump and hydraulic device, occur separately from one another. This means that a plurality of steps are necessary for filling and connecting, and therefore the assembly effort is increased.

Thus a need exists to specify a vibration damper by means of which the assembly effort during installation in a vehicle is reduced and which is cost-effective. The disclosure is further based on specifying a motor vehicle and a method for filling.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic illustration of a vibration damper according to a preferred exemplary embodiment according to the invention, wherein an external motor pump is shown in addition in a schematic manner.

FIG. 2 shows a cross section through a valve block and a shut-off valve, which is integrated therein, of the vibration damper according to FIG. 1.

FIG. 3 shows a cross section through the valve block and the shut-off valve, which is integrated therein, of the vibration damper according to FIG. 2, wherein a nozzle and a fastening unit are provided and a valve piston of the shut-off valve is in a first switching position.

FIG. 4 shows a cross section through the valve block and the shut-off valve, which is integrated therein, of the vibration damper according to FIG. 3, wherein the valve piston of the shut-off valve is in a second switching position; and

FIG. 5 shows a cross section through a valve block and a shut-off valve, which is integrated therein, of a vibration damper according to a further preferred exemplary embodiment according to the invention, wherein a nozzle and a fastening unit are provided and a valve piston of the shut-off valve is in a first switching position.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art

Specifically, some embodiments include a vibration damper, in particular for a motor vehicle, comprising:
a hydraulic device for damping vibrations;
a valve block and at least one shut-off valve integrated into the valve block and having at least one valve piston which is displaceable in a valve longitudinal direction for taking up at least two switching positions; and
at least one nozzle for connecting a pump, which nozzle is adjustably fastened to the valve block, wherein the nozzle interacts with the valve piston for displacement between the switching positions, wherein
   in the first switching position of the valve piston, the nozzle is fluidly separated from the hydraulic device and can be fluidly connected to at least one filling device for filling the pump with a hydraulic fluid, and in the second switching position of the valve piston, the nozzle is fluidly connected to the hydraulic device.

The invention has the essential idea of displacing the valve piston of the shut-off valve between at least two switching positions in the valve longitudinal direction by interacting with the nozzle. The nozzle is preferably arranged adjustably on the valve block in such a way that, by adjusting, the nozzle displaces the valve piston in the valve longitudinal direction in order to take up the first or second switching position. For this purpose, the nozzle is preferably displaceable in the valve longitudinal direction. By means of the nozzle, the valve piston is thus movable in the valve longitudinal direction.

The nozzle preferably forms an actuating element to actuate the valve piston of the shut-off valve, i.e. to move it between the switching positions. No additional step is thus necessary to actuate the valve piston, as this is taken over by the nozzle.

In the first switching position, the nozzle can be fluidly connected to a filling device via the shut-off valve on the one hand and is separated from the hydraulic device of the vibration damper on the other hand. It is preferable if the hydraulic device of the vibration damper is pre-filled with a hydraulic fluid. Since the valve piston shuts off a passage to the hydraulic device in the first switching position, a pre-filled hydraulic fluid cannot escape. During assembly, in particular initial assembly, on or in a vehicle, it is often the case that a pump is/ has been pre-assembled, especially in the case of active damping systems. In this case, the pre-filled vibration damper is installed on the vehicle. Up to this point in time, the vibration damper and the pump form separate units which can be handled and assembled independently of each other. This makes assembly much easier.

The pump is then fluidly connected to the nozzle, which is adjustably fastened to the valve block, to realize the active damping system. This preferably occurs via a hose line. A rigid line is also possible. At this point in time, the nozzle for connecting the pump is still in the first switching position, i.e. a passage to the hydraulic device, which is preferably pre-filled, is blocked. The nozzle is then fluidly connected to a filling device in such a way that the connected pump is filled with a hydraulic fluid. If the pump is completely filled with the hydraulic fluid, the connection to the filling device is disconnected.

The nozzle is then adjusted on the valve block. Since the nozzle interacts with the valve piston, the valve piston is transferred from the first switching position to the second switching position by adjusting the nozzle. In the second switching position, the nozzle is fluidly connected to the hydraulic device. In other words, the filled pump and the pre-filled hydraulic device of the vibration damper are fluidly connected to one another by transferring the valve piston from the first switching position to the second switching position, thus forming an active damping system.

The invention thus has the great advantage that the assembly of such a system is simplified. The arrangement of the nozzle, i.e. the pump connection, in the valve longitudinal direction also results in the advantage that an actuation of the valve piston is simplified. The basic design of the shut-off valve is improved and cost-effective.

The invention has the further advantage that, in the event of damage, the shut-off valve according to the invention allows a quick and uncomplicated replacement of the pump or the vibration damper.

At this point it is clarified that the valve block is arranged on the vibration damper, specifically directly on the vibration damper. The shut-off valve forms part of the valve block.

In a preferred embodiment, at least one fastening unit for fastening the nozzle is provided by means of which the nozzle can be fixed to the valve block and/or the shut-off valve at at least two positions in the valve longitudinal direction. Preferably, the valve piston is in the first switching position in the first position of the nozzle. In the second position of the nozzle, the valve piston is preferably in the second switching position. The fastening unit thus fixes the nozzle to the valve block at the two positions. Here it is advantageous that the fastening unit is designed or adapted to not only fasten the nozzle to the valve block, but also to adjust its position in the valve longitudinal direction in order to actuate the valve piston. The structural design is thus simplified by functional integration.

It should be noted that the first position of the nozzle in the valve longitudinal direction is further away from the valve block or the shut-off valve than the second position of the nozzle. In other words, the second position of the nozzle in the valve longitudinal direction is closer to the valve block or the shut-off valve than the first position of the nozzle.

Preferably, the fastening unit has at least one fastening means which is coupled to the nozzle, wherein the nozzle is adjustable by the fastening means relative to the valve block or to the shut-off valve in the valve longitudinal direction. The position of the nozzle can be adjusted via the fastening means, the nozzle interacting with the valve piston. The valve piston is thus indirectly displaceable between the two switching positions via the fastening means. This is a very simple design for adjusting the valve piston between the switching positions in order to carry out filling of the pump and then connection to the hydraulic device.

The fastening means is preferably a screw which is screwed into the valve block in the valve longitudinal direction. Depending on a screwing-in depth of the screw, the nozzle is in the first or second position and thus the valve piston is therefore in the first or second switching position.

It is advantageous if at least one spacer is provided on the valve block, which spacer defines the first position of the nozzle with respect to the valve block or the shut-off valve in such a way that the valve piston is in the first switching position. Particularly in the variant of the fastening unit with only one fastening means, this guarantees the exact adoption of the first switching position of the valve piston. The spacer preferably has a thickness which corresponds to the distance between the two switching positions in the valve longitudinal direction. The spacer is a component which preferably limits an adjustment distance of the nozzle in the valve longitudinal direction. The spacer is a temporary component which is used, in particular only used, to take up the first switching position. In the second switching position, the spacer is removed.

In a further preferred embodiment, the fastening unit has at least two fastening means with different lengths, wherein the fastening means project into the valve block and, at full projection depth, each define one of the two positions of the nozzle in the valve longitudinal direction. Here it is advantageous that the first position is defined by one fastening means and the second position of the nozzle is defined by the other fastening means. As a result, the two switching positions of the valve piston can be exactly taken up. At least one of the two fastening means, in particular or both fastening means, fix the nozzle in the final, second position on the valve block.

Preferably, the fastening unit has at least one holding element, in particular a holding plate, which holds the nozzle and prevents a movement of the nozzle in a valve longitudinal direction leading away from the valve piston. The holding element prevents the nozzle from releasing from the valve block or the shut-off valve. In addition, the holding element transmits an adjustment movement from one or more fastening means. In other words, the holding element is preferably mechanically coupled to the one or more fastening means. The one or more fastening means can fasten the nozzle to the valve block and/or the shut-off valve via the holding element.

In a preferred embodiment, the shut-off valve has a housing in which the valve piston is guided in a longitudinally displaceable manner, wherein the housing has, on a first longitudinal end of the housing opposite the nozzle, a guide opening through which the valve piston extends. The valve piston is thus partially integrated into the housing, wherein the housing fulfils a guide function for the valve piston.

Preferably, the nozzle is at least partially received in the housing of the shut-off valve, wherein the nozzle is in contact with the valve piston in the valve longitudinal direction. In other words, the nozzle partially projects into the housing and is in contact with the valve piston in order to transmit an adjustment movement of the nozzle to the valve piston. This allows the valve piston to take up its first and second switching position. A compact design is realized through component integration. Particularly preferably, the valve piston and the nozzle are situated behind one another on a common longitudinal axis. The valve piston and the nozzle are preferably arranged one after the other in the valve longitudinal direction.

Further preferably, the valve piston has at least one collar which is arranged outside the housing and interacts in a sealing manner with the housing, in particular by means of a sealing element, in the first switching position. The valve piston is preferably mushroom-shaped. The collar preferably extends transversely to the valve longitudinal direction. In the first switching position, the collar seals against the housing, thereby preventing a flow of hydraulic fluid. In the second switching position, the collar is spaced apart from the housing, thereby allowing a flow. The valve piston is of simple design.

The shut-off valve may comprise at least one guide sleeve which is arranged transversely to the valve longitudinal direction between the valve piston and the housing and guides the valve piston along an inner side of the housing during a displacement operation. The guide sleeve is preferably in direct contact with the inner side of the housing and an outer circumference of the valve piston. The guide sleeve stabilizes the valve piston during transfer between the two switching positions in the housing.

It is advantageous if the shut-off valve has at least one spring element, in particular a coil spring, which preloads the valve piston in a valve longitudinal direction leading to the nozzle. In other words, the spring element preloads the valve piston towards the nozzle. By means of the spring element, the shut-off valve is resiliently closing in a state not actuated by the nozzle. The spring element can hold the valve piston in a stable manner in the first switching position, in particular in interaction with the nozzle. The spring element can be a return spring for the valve piston.

The spring element can be supported on the one hand on the housing in the region of the guide opening and on the other hand can directly or indirectly interact with the longitudinal end of the valve piston near the nozzle. The spring element can interact with the longitudinal end of the valve piston near the nozzle via the guide sleeve, i.e. indirectly. Alternatively, the spring element can directly act on the valve piston at the longitudinal end near the nozzle.

Preferably, the valve piston has at least one support portion at a longitudinal end near the nozzle, which support portion extends at least partially transversely to the valve longitudinal direction, wherein the guide sleeve and/or the spring element lies against the support portion in the valve longitudinal direction. The support portion preferably comprises a form-fitting element with which the spring element or the guide sleeve is in contact in such a way that a form fit is formed in the valve longitudinal direction. The spring force of the spring element is thus efficiently introduced into the valve piston. No weld seam or screw connection is required, and therefore the connection of the guide sleeve or spring element with the valve piston is simplified.

The filling device preferably comprises at least one filling valve which allows a flow in a flow direction leading to the shut-off valve and blocks the flow in a flow direction leading away from the shut-off valve. The filling valve preferably comprises a check valve. In this way, a flow is only realized when a hydraulic fluid is supplied to the shut-off valve and thus to the nozzle for filling the pump (first switching position). If the filling device is separated from the shut-off valve or the valve block, the flow is shut off. The filled pump can be connected to the hydraulic device of the vibration damper (second switching position).

According to an independent aspect, the invention relates to a vehicle, in particular a motor vehicle, having a vibration damper according to the invention.

According to a further independent aspect, the invention relates to a method for filling a pump and connecting the pump to a hydraulic device of a vibration damper, in particular for a motor vehicle, wherein the vibration damper comprises a valve block and at least one shut-off valve integrated into the valve block and having at least one valve piston which is displaced in a valve longitudinal direction for taking up at least two switching positions, and comprises at least one nozzle for connecting a pump, which nozzle is adjustably fastened to the valve block, wherein the nozzle interacts with the valve piston for displacement between the switching positions, wherein the nozzle is fluidly separated from the hydraulic device by the valve piston taking up the first switching position and is fluidly connected to at least one filling device for filling the pump with a hydraulic fluid, and the nozzle is fluidly connected to the hydraulic device by the valve piston taking up the second switching position.

Preferably, the pump is evacuated by applying a vacuum before filling with hydraulic fluid.

With regard to the motor vehicle and the method, reference is made to the advantages explained in connection with the vibration damper. Moreover, the motor vehicle and the method may alternatively or additionally have individual features or a combination of a plurality of features mentioned above in relation to the vibration damper.

The invention is explained in more detail below with further details with reference to the appended drawings. The embodiments illustrated provide examples of how the vibration damper according to the invention can be designed.

In the following, the same reference numbers are used for identical and identically acting parts.

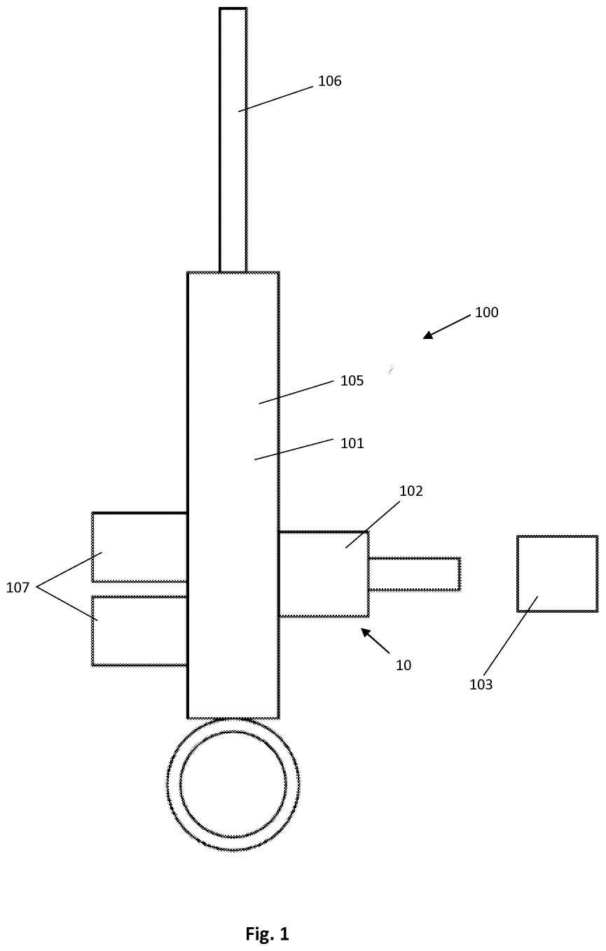

FIG. 1 shows by way of example a vibration damper 100 according to a preferred exemplary embodiment according to the invention. The vibration damper 100 has a hydraulic device 101 for damping vibrations, which is filled with a hydraulic fluid. The hydraulic device 101 comprises a cylinder tube 105 and a working piston (not shown) which is axially displaceable in the cylinder tube 105 and which is arranged on a piston rod 106. The vibration damper 100 is a multi-tube damper, for example a two-tube damper. The vibration damper 100 can alternatively be designed as a single-tube damper. The invention does not restrict this.

Two damper valves 107 are arranged laterally for setting or adjusting a damping of the vibration damper 100. The damper valves 107 are preferably formed as solenoid valves.

Furthermore, FIG. 1 shows a valve block 102 which by way of example is arranged laterally on the cylinder tube 105 of the hydraulic device 101. The valve block 102 is fixedly connected to the cylinder tube 105. Also schematically illustrated is an external pump 103, in particular a motor pump, which is either fluidly connected or fluidly connectable to the hydraulic device 101 via the valve block 102. In order to enable the coupling and decoupling of the pump 103 to and from the valve block 102, the vibration damper 100 has at least one shut-off valve 10. The shut-off valve 10 also enables the pump 103 to be filled with hydraulic fluid before the fluid connection with the hydraulic device 101.

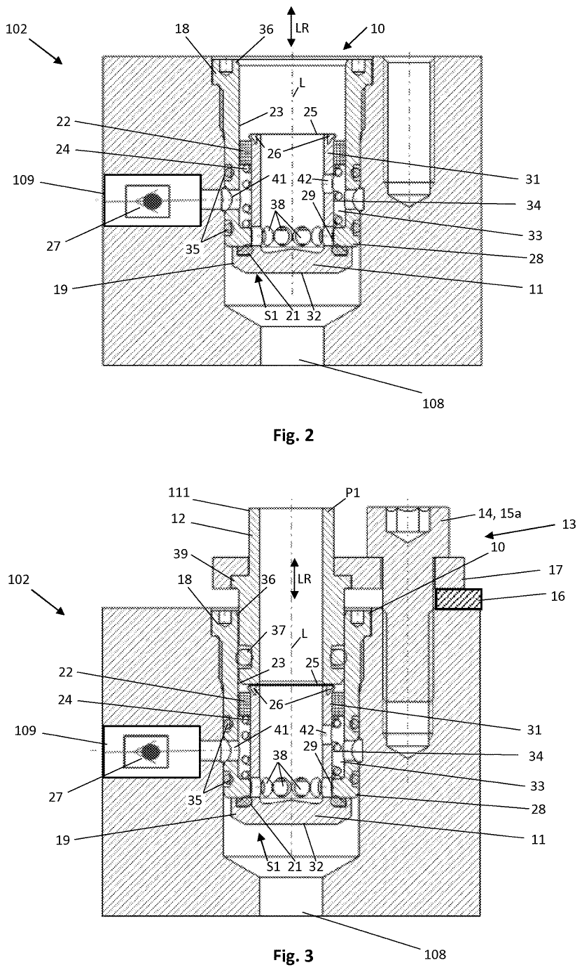

The shut-off valve 10 is integrated into the valve block 102. Specifically, the shut-off valve 10 is screwed into the valve block 102. This is readily discernible in FIGS. 2 to 5. The valve block 102 has a first port 108 by means of which the shut-off valve 10 is fluidly connected to the hydraulic device 101. Furthermore, the valve block 102 has a second port 109 by means of which the shut-off valve can be fluidly connected to a filling device for filling the pump 103 with hydraulic fluid. A third port 111 is provided by a nozzle 12 for connecting the pump 103, which nozzle forms a separate component. The nozzle 12 will be discussed in more detail later.

In the following, the shut-off valve 10 will be discussed, wherein the shut-off valves 10 of the first embodiment and the second embodiment are identical. The embodiments differ only in the type and design of a fastening unit 13, which will be discussed in more detail later.

The respective shut-off valve 10 has a housing 18 and a valve piston 11 which is axially displaceable in the housing 18. The valve piston 11 is displaceable between two switching positions S1, S2 in the valve longitudinal direction LR. The shut-off valve 10 has a longitudinal axis L, wherein the housing 18 and the valve piston 11 are arranged so as to lie coaxially on the longitudinal axis L. As shown in FIGS. 2 to 5, the housing 18 is designed to be hollow. The housing 18 is substantially cylindrical. The housing 18 partially receives the valve piston 11.

As is shown in FIGS. 2 to 5, the valve piston 11 is mushroom-shaped. The valve piston 11 has a cylindrical portion 31 which projects into the housing 18. The housing 18 specifically comprises a guide opening 29 which is formed on a first longitudinal end 28 of the housing 18 that is opposite to the nozzle 12. The cylindrical portion 31 extends through the guide opening 29 in such a way that the valve piston 11 is guided in a longitudinally displaceable manner.

A collar 19 is formed on a longitudinal end 32 of the valve piston 11 remote from the nozzle, which collar extends outwardly transversely to the longitudinal axis L. The collar 19 forms a piston head which is arranged outside the housing 18. The collar 19 has at least one sealing element 21 facing the housing 18. The sealing element 21 can be an O-ring. In the region of the collar 19 there are formed a plurality of through openings 38 which lead through the cylindrical portion 31 from the inside to the outside in order to allow a flow of the hydraulic fluid when the pump 103 is fluidly connected to the hydraulic device 101.

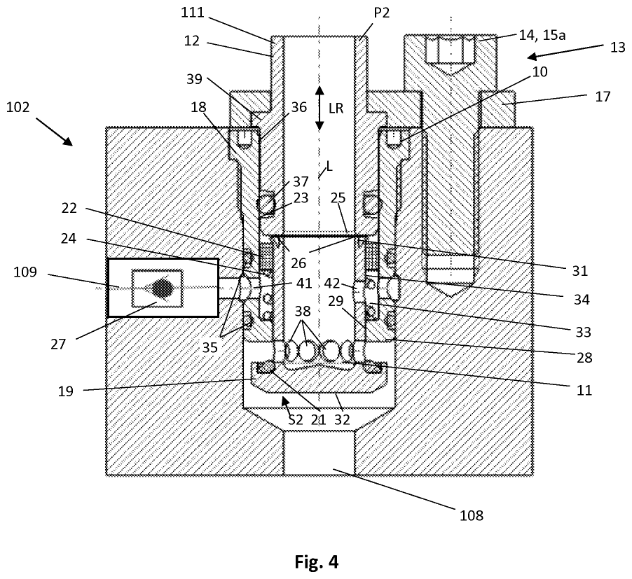

As can be seen from the different positions of the valve piston 11 according to FIGS. 3 and 4, the valve piston 11 is mounted so as to be displaceable in the valve longitudinal direction LR. The valve piston 11 is guided in a longitudinally displaceable manner in the housing 18 in such a way that a displacement movement in the valve longitudinal direction is carried out free of a rotation of the valve piston 11.

FIGS. 2 to 5 further show that the shut-off valve 10 comprises a spring element 24 and a guide sleeve 22. The spring element 24 preloads the valve piston 11 in a valve longitudinal direction LR leading to the nozzle 12. In the present case, the spring element 24 is a coil spring. The spring element 24 is used to guide the valve piston 11 into its closed position and to hold it there even if the nozzle 12 is not provided. The spring element 24 is supported on the one hand on the housing 18 in the region of the guide opening 29 and, on the other hand, the spring element 24 interacts with a longitudinal end 25 of the valve piston 11 close to the nozzle via the guide sleeve 22.

For the support of the spring element 24, the housing 18 has, in the region of the guide opening 29, a housing portion extending with respect to the longitudinal axis L. This housing portion delimits the guide opening 29 radially.

As can be seen in FIGS. 2 to 5, the spring element 24 and the guide sleeve 22 are arranged radially between the valve piston 11 and the housing 18. Specifically, between an inner side 23 of the housing 18 and the valve piston 11 there is formed a gap 33, in particular an annular gap, in which the guide sleeve 22 and the spring element 24 are arranged.

The guide sleeve 22 bridges the gap 33 between an outer side 34 of the valve piston 11 and the inner side 23 of the housing 18 transversely to the valve longitudinal direction LR. On the one hand, the guide sleeve 22 lies against a support portion 26 of the valve piston 11 in the valve longitudinal direction LR and, on the other hand, the spring element 24 lies on an opposite side of the guide sleeve 22 in the valve longitudinal direction LR in order to intro-duce a spring force, in particular a preloading force, via the sleeve 22 into the valve piston 11. During a displacement operation of the valve piston 11, the guide sleeve 22 slides along on the inner side 23 of the housing 18 and thus guides the valve piston 11.

The support portion 26 extends outwardly transversely to the valve longitudinal direction LR, in particular to the longitudinal axis L. The support portion 26 is formed by form-fitting elements which project radially from the outer side 34 of the valve piston 11. In the valve longitudinal direction LR, the guide sleeve 22 is thus held in a form-fitting manner. The form-fitting elements indirectly form an abutment for the spring element 24.

It can also be seen in FIGS. 2 to 5 that two sealing elements 35 are arranged outer circumferentially on or in the housing 18 and seal a channel, which forms a connection to the second port 109, on both sides in the valve longitudinal direction LR. The sealing elements 35 can be O-rings.

The vibration damper 100 additionally comprises a nozzle 12 for connecting the pump 103, which nozzle has already been mentioned above (see FIGS. 3 to 5). The nozzle 12 is partially inserted into the housing 18. In other words, the housing 18 partially receives the nozzle 12. The nozzle 12 projects into the housing 18 at its second longitudinal end 36. The nozzle 12 has an inside diameter which corresponds to the inside diameter of the cylindrical portion 31 of the valve piston 11.

The nozzle 12 is arranged coaxially with the valve piston 11. The nozzle 12 is in direct contact with the valve piston 11 in the valve longitudinal direction LR. Specifically, the nozzle 12 interacts with the longitudinal end 25 of the valve piston 11 near the nozzle in order to displace this valve piston between two switching positions. The nozzle 12 is coupled with the valve piston 11 end to end. The nozzle 12 and the valve piston 11, in particular its cylindrical portion 31, form a common fluid channel in the valve longitudinal direction LR.

The nozzle 12 is mounted in the housing 18 in the valve longitudinal direction LR, i.e. in a longitudinally displaceable manner. For sealing against the inner side 23 of the housing 18, the nozzle 12 comprises a sealing element 37, which is preferably an O-ring. The nozzle 12 is designed as a connection nipple.

In order to fasten the nozzle 12 to the valve block 102 on the one hand and to adjust it in the valve longitudinal direction LR on the other hand, a fastening unit 13 is provided. The fastening unit 13 is designed to fix the nozzle 12 at at least two positions P1, P2 in the valve longitudinal direction LR and to move it between the two positions P1, P2.

As is shown in FIGS. 3 and 4, the fastening unit 13 has a fastening means 14, specifically a screw 15a, and a holding element 17, specifically a holding plate. The screw 15a is screwed into the valve block 102 in an offset manner transversely to the longitudinal axis L of the shut-off valve 10. The screw 15a runs parallel to the longitudinal axis L of the shut-off valve 10. Specifically, the screw 15a is screwed into a blind bore which has an internal thread.

The holding plate 17, via which the screw 15a is coupled to the nozzle 12, extends transversely to the valve longitudinal direction LR. It can be seen that the holding plate 17 holds the nozzle 12 on a collar 39 which is formed on the outside of the nozzle 12. The holding plate 17 limits a movement of the nozzle 12 in a valve longitudinal direction LR leading away from the valve piston 11. Via the screw 15a, the nozzle 12 is displaceable in the valve longitudinal direction LR and thus also moves the valve piston 11 between the two switching positions S1, S2.

FIG. 3 shows a first position P1 of the nozzle 12, in which the collar 39 is spaced apart from the valve block 102. In this position, the valve piston 11 is in a first switching position S1, in which the nozzle 12 is fluidly separated from the first port 108 and thus the hydraulic device 101. In addition, however, the nozzle 12 is fluidly connected to the second port 109 in the first switching position S1 and thus can be fluidly connected to a filling device. FIG. 3 further shows that a spacer 16 is arranged between the holding plate 17 and the valve block 102. The spacer 16 defines the first position P1 of the nozzle 12 and thus the first switching position S1 of the valve piston 11 in the valve longitudinal direction LR and thus prevents the shut-off valve 10 from being partially opened during a filling operation. The thickness of the spacer 16 corresponds to the adjustment distance between the two positions P1, P2 of the nozzle 12 and thus between the two switching positions S1, S2 of the valve piston 11.

If a filling operation is then completed, i.e. a pump 103 connected to the nozzle 12 is completely filled with hydraulic fluid, the connection to the filling device is disconnected. As can be seen in FIGS. 2 to 5, a filling valve 27 is provided which is designed as a check valve. The filling valve 27 blocks a return flow from the shut-off valve 10 to the outside, but ensures a flow during filling. The filling valve 27 can be integrated into the valve block 102 or be arranged externally on the valve block 102.

Before filling the pump 103, the latter is evacuated. This preferably occurs by applying a vacuum.

It is also revealed that the first port 108 is formed in the valve longitudinal direction LR. By contrast, the second port 109 is provided transversely to the valve longitudinal direction LR. In order to realize a fluid connection between the second port 109 and the nozzle 12, the housing 18 has an opening 41 which fluidly connects the gap 33 to the second port 109. The valve piston 11 comprises a further opening 42, which leads from the gap 33 into an interior of the valve piston 11, as a result of which a fluid connection to the nozzle 12 is established.

At the same time or subsequently to the decoupling of the filling device, the spacer 16 is removed and the screw 15a is screwed into the valve block 102 until the holding plate 17 and the collar 39 of the nozzle 12, which are flush, lie directly against the valve block 102. The nozzle 12 is then in the second position P2. By the interaction of the nozzle 12 with the valve piston 11, the valve piston 11 is displaced from the first switching position S1 into the second switching position S2. As a result, the through openings 38 are released. In the second switching position S2, there is a passage from the nozzle 12 to the first port 108 of the valve block 102. This means that the pump 103 and the hydraulic device 101 are fluidly connected and the vibration damper 100 is ready for operation. This state is shown in FIG. 4.

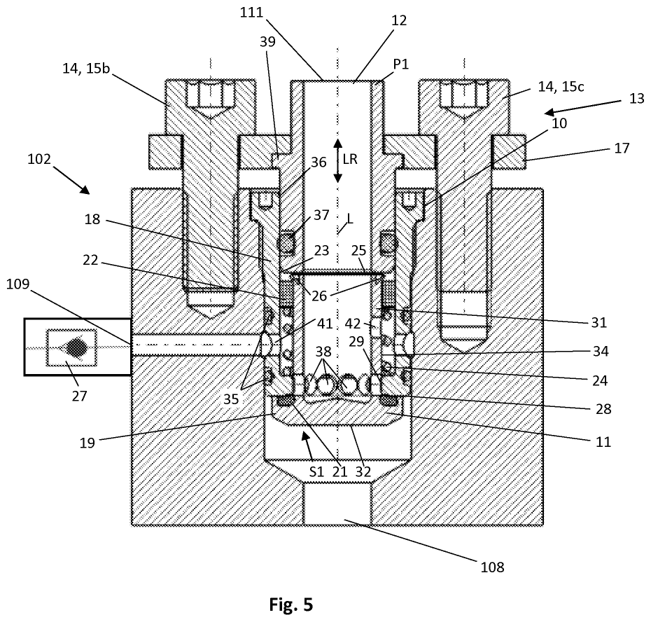

In the embodiment according to FIG. 5, the spacer 16 is omitted. In order to ensure that the valve piston 11 can take up the first and second switching position S1, S2 exactly, instead of a screw, as shown in FIGS. 3 and 4, two screws 15 b, c with different screw lengths are provided. Specifically, the fastening unit 13 has a first screw 15b and a second screw 15c. The first screw 15 b is shorter than the second screw 15 c. The screws 15b, c are each screwed into a blind hole with an internal thread. The blind hole depth of the first screw 15b is formed in such a way that, at full screw-in depth, the first screw 15b moves the nozzle 12 via the holding plate 17 into the first position P1 and fixes it there. In this position P1, the valve piston 11 is in the first switching position S1, in which filling of the pump 103 can occur. The second screw 15c is screwed into the associated blind hole, wherein an internal thread length of this blind hole is longer than that of the blind hole of the first screw 15b.

If a filling operation is completed, the second screw 15c is screwed completely into the blind hole. At the full screw-in depth of the second screw 15c, the nozzle 12 is moved via the holding plate 17 into the second position P2 and fixed there. The holding plate 17 and the collar 39 lie flush against the valve block 102. By the interaction of the nozzle 12 with the valve piston 11, the valve piston 11 is displaced from the first switching position S1 into the second switching position S2. As a result, the through openings 38 are released. In the second switching position S2, there is a passage from the nozzle 12 to the first port 108 of the valve block 102. This means that the pump 103 and the hydraulic device 101 are fluidly connected and the vibration damper 100 is ready for operation.

### LIST OF REFERENCE SIGNS

10 Shut-off valve
11 Valve piston
12 Nozzle
13 Fastening unit
14 Fastening means
15a Screw
15b First screw
15c Second screw
16 Spacer
17 Holding element
18 Housing
19 Collar
21 Sealing element
22 Guide sleeve
23 Inner side of the housing
24 Spring element
25 Longitudinal end near the nozzle
26 Support portion
27 Filling valve
28 Opposite first longitudinal end of the housing
29 Guide opening
31 Cylindrical portion
32 Longitudinal end remote from the nozzle
33 Gap
34 Outer side of the valve piston
35 Sealing elements
36 Second longitudinal end of the housing
37 Sealing element
38 Through openings
39 Collar of the nozzle
41 Opening in the housing
42 Further opening in the valve piston
100 Vibration damper
101 Hydraulic device
102 Valve block
103 Pump
105 Cylinder tube
106 Piston rod
107 Damper valves
108 First port
109 Second port
111 Third port
S1 First switching position
S2 Second switching position
P1 First position
P2 Second position
LR Valve longitudinal direction
L Longitudinal axis of the shut-off valve

1. A vibration damper, comprising:
a hydraulic device for damping vibrations;
a valve block and at least one shut-off valve integrated into the valve block and having at least one valve piston which is displaceable in a valve longitudinal direction for taking up at least two switching positions; and
at least one nozzle for connecting a pump, which nozzle is adjustably fastened to the valve block, wherein the nozzle interacts with the valve piston for displacement between the switching positions;
wherein, in the first switching position of the valve piston, the nozzle is fluidly separated from the hydraulic device and can be fluidly connected to at least one filling device for filling the pump with a hydraulic fluid, and in the second switching position of the valve piston, the nozzle is fluidly connected to the hydraulic device.

2. The vibration damper according to claim 1, wherein at least one fastening unit for fastening the nozzle is provided, by which the nozzle can be fixed to the valve block and/or the shut-off valve at at least two positions in the valve longitudinal direction.

3. The vibration damper according to claim 2, wherein the fastening unit has at least one fastener, in particular a screw, which is coupled to the nozzle, wherein the nozzle is adjustable by the fastener relative to the valve block or to the shut-off valve in the valve longitudinal direction.

4. The vibration damper according to claim 2, wherein the fastening unit has at least two fasteners, in particular two screws, of different lengths, wherein the fasteners project into the valve block and, at full projection depth, each define one of the two positions of the nozzle in the valve longitudinal direction.

5. The vibration damper according to claim 1, wherein at least one spacer is provided on the valve block, which spacer defines a first position of the nozzle with respect to the valve block or the shut-off valve in such a way that the valve piston is in the first switching position.

6. The vibration damper according to claim 1, wherein the fastening unit has at least one holding element, in particular a holding plate, which holds the nozzle and prevents a movement of the nozzle in a valve longitudinal direction leading away from the valve piston.

7. The vibration damper according to claim 1, wherein the one or more fasteners fasten the nozzle to the valve block and/or the shut-off valve via the holding element.

8. The vibration damper according to claim 1, wherein the shut-off valve has a housing in which the valve piston is guided in a longitudinally displaceable manner, wherein the housing has, on a first longitudinal end, opposite the nozzle, of the housing, a guide opening through which the valve piston extends.

9. The vibration damper according to claim 8, wherein the nozzle is at least partially received in the housing of the shut-off valve, wherein the nozzle is in contact with the valve piston in the valve longitudinal direction.

10. The vibration damper according to claim 8, wherein the valve piston has at least one collar which is arranged outside the housing and interacts in a sealing manner with the housing, in particular by a sealing element, in the first switching position.

11. The vibration damper according to claim 8, wherein the shut-off valve has at least one guide sleeve which is arranged transversely to the valve longitudinal direction between the valve piston and the housing and guides the valve piston along an inner side of the housing during a displacement operation.

12. The vibration damper according to claim 1, wherein the shut-off valve has at least one spring element, in particular a coil spring, which preloads the valve piston in a valve longitudinal direction leading to the nozzle.

13. The vibration damper according to claim 12, wherein the spring element is on the one hand supported on the housing in the region of the guide opening and on the other hand directly or indirectly interacts with a longitudinal end of the valve piston near the nozzle.

14. The vibration damper according to claim 8, wherein the valve piston has, on a longitudinal end near the nozzle, at least one support portion which extends at least partially transversely to the valve longitudinal direction, wherein the guide sleeve and/or the spring element lies against the support portion in the valve longitudinal direction.

15. The vibration damper according to claim 1, wherein the filling device comprises at least one filling valve which enables a flow in a flow direction leading to the shut-off valve and blocks the flow in a flow direction leading away from the shut-off valve.

16. The vibration damper according to claim 1, wherein the vibration damper is a vibration damper for a motor vehicle.

17. A motor vehicle having a vibration damper according to claim 1.

18. A method for filling a pump and connecting the pump to a hydraulic device of a vibration damper, wherein the vibration damper includes a valve block and at least one shut-off valve integrated into the valve block and has at least one valve piston which is displaced in a valve longitudinal direction for taking up at least two switching positions, and includes at least one nozzle for connecting a pump, which nozzle is adjustably fastened to the valve block, wherein the nozzle interacts with the valve piston for displacement between the switching positions, wherein the nozzle is fluidly separated from the hydraulic device by the valve piston taking up the first switching position and is fluidly connected to at least one filling device for filling the pump with a hydraulic fluid, and the nozzle is fluidly connected to the hydraulic device by the valve piston taking up the second switching position.

19. The method according to claim 18 wherein the pump is evacuated by applying a vacuum before filling with hydraulic fluid.

20. The method according to claim 18 wherein the vibration damper is a vibration damper for a motor vehicle.
